(19) United States
(12) Patent Application Publication
(10) Pub. No.: US 2023/0303464 A1
(43) Pub. Date: Sep. 28, 2023

(54) AN ORGANIC AGRICULTURAL COMPOSITION

(71) Applicant: Hiteshkumar Anilkant DOSHI, Thane (IN)

(72) Inventor: Hiteshkumar Anilkant DOSHI, Thane (IN)

(21) Appl. No.: 18/022,085

(22) PCT Filed: Nov. 8, 2021
(86) PCT No.: PCT/IB2021/057529

§ 371 Date: Feb. 17, 2023

(30) Foreign Application Priority Data
Aug. 17, 2020 (IN) IN202021035373

(51) Int. Cl. C05G 5/27; C05D 9/00; C05G 5/12

(52) U.S. Cl. CPC C05G 5/27; C05D 9/00; C05G 5/12

(57) ABSTRACT

The present invention relates to an organic agricultural composition comprising elemental sulphur and at least one hydrocolloid, wherein the composition is in the granular or suspension form, and wherein the hydrocolloid has viscosity of ≤400 cps at ≤30% (w/w) aqueous dispersion of the hydrocolloid.

The invention also relates to a process of preparing an organic agricultural composition comprising elemental sulphur and at least one hydrocolloid; wherein the composition is in the form of water dispersible granules or spheronised granules or suspension, and wherein the hydrocolloid has viscosity of ≤400 cps at ≤30% (w/w) aqueous dispersion of the hydrocolloid.

### 1. FIELD OF THE INVENTION

The present invention relates to an organic agricultural composition comprising elemental sulphur and at least one hydrocolloid. The present invention particularly relates to an organic agricultural composition comprising elemental sulphur and at least one hydrocolloid, wherein the hydrocolloid has a viscosity of less than or equal to (≤) 400 cps at less than or equal to (≤) 30% (w/w) aqueous dispersion of the hydrocolloid. The organic agricultural composition is in the granular or suspension form and the composition comprises particles in the size range of 0.1 micron to 25 microns.

The invention further relates to a process of preparing an organic agricultural composition comprising elemental sulphur and at least one hydrocolloid; wherein the hydrocolloid has a viscosity of ≤400 cps at ≤30% (w/w) aqueous dispersion of the hydrocolloid; wherein the composition is in the form of water dispersible granules or spheronised granules or suspension.

### 2. BACKGROUND OF THE INVENTION

In describing the embodiment of the invention, specific terminology is chosen for the sake of clarity. However, it is not intended that the invention be limited to the specific terms so selected and it is to be understood that each specific term include all technical equivalents that operate in a similar manner to accomplish a similar purpose.

Besides the increasing labor shortage, water shortage, demand on high and quality yields, the current farming practices are greatly challenged by deteriorating soil health, decreasing fertility of soil, leaching of fertilizers and pesticides, micronutrient deficiencies in the soil, and so on.

One of the root causes of the deteriorating soil health and increasing environmental pollution is the excessive use of chemical fertilizers and pesticides. Several agrochemical agents are being used at high dosages for long periods of time as fertilizers and for countering pests and diseases. These chemical agents are a constant burden on the environment as they contaminate the soil, water, turf, and other vegetation. In addition to countering pests and diseases, they can be toxic to a host of other organisms including birds, fish, beneficial insects, and non-target plants. Most of the agrochemical agents leach into the soil, contaminate groundwater and can end up in drinking water also. The sprays can drift and pollute the air. Further nutrient losses are also a cause for concern due to the economics, as well as due to environmental reasons. Besides, the agricultural produce using chemical fertilizers, pesticides, weedicides are also showing adverse effects on health of people and are also corelated to disease conditions in humans.

There is a greater need today to optimize farming and agriculture practices by avoiding the use of synthetic chemicals, pesticides, chemical adjuvants and excipients and thereby reduce the burden on the environment by reducing the number of chemicals being added to the soil and the crops.

In view of the same, there is a need to develop an agricultural composition, which is organic in nature and provides suitable nutrients to the soil on one hand, and also simultaneously provides a pesticidal/insecticidal control for managing various pests and reduces the burden on the environment, avoids the amount of chemicals added to the soil and the crop and also reduces the burden on the farmer, in terms of labor and costs.

The role of sulphur as an essential and a growing nutrient and fertilizer has been long known. Sulphur is considered as organic in nature and is largely available in its elemental form. Additionally, elemental sulphur is allowed for organic farming as plant or soil amendments, for plant disease control and as insecticides including acaricides and miticides. For the sulphur to be usable by the plants, the elemental sulphur has to be oxidized into its sulphate form. The benefits of use of elemental sulphur encompasses not only reduced dependency on use of chemicals as an effective mode of pest control but being organic in nature it is also environment friendly, increases crop yield, improves food safety, human, animal or plant health and quality of life.

Though the benefits of sulphur are well known, the deficiency of sulphur has become widespread over the past several decades in most of the agricultural areas of the world, resulting in sulphur being indicated as a limiting factor to high yields and fertilizer efficiency. One of the reasons for deficiency is the non-availability of sulphur when applied as a sulphate-based fertilizer, and this can be attributed due to losses caused by leaching and soil pH. Further, the reason for unavailability of elemental Sulphur to the plant is usually due to the form in which elemental Sulphur is applied, thereby not providing enough Sulphur for the plant to assimilate. Further, sulphur being a member of the class of substances having water-repellant surface is incapable of intimate contact with moisture and thereby floats on water and does not disperse.

The conventional state-of-the-art sulphur based fertilizer products comprises elemental sulphur with synthetic carrier medium including chemicals, chemical adjuvants and excipients, which adds the number of chemicals being added to the soil and the crops and poses residue related problems, soil deterioration and toxic effect on human beings and reduced yield. Furthermore, elemental sulfur in powdered form besides creating dust which irritates the eyes and being hazardous to the health of farmers, can also flow away with water during rains or irrigation thereby contaminating the water bodies.

Water dispersible granules comprising elemental Sulphur are known in the art and considered to be the most advanced form of elemental Sulphur fertilizers with a high nutrient use efficiency. These are prepared with various chemical surfactants which have long term effects on the environment and contribute to ground water contamination with far reaching effects on mammalian and aquatic life. Many of these surfactants are not biodegradable and remain in the soil for over months and years. One of the commonly used surfactants in the preparation of such water dispersible granules are lignin sulphonates. High doses of sodium lignin sulphonate have been found to cause adverse health effects in laboratory animals. In a study with guinea pigs and rabbits administered sodium lignosulfonate at a 1 percent concentration for a two- to six-week period, a high percentage of the animals developed ulcerative colon disease (Marcus and Watts, 1974). While natural lignin is considered to be an important component of secondary cell walls in vascular plants and is the second most abundant plant derived organic substance, as larger volumes of fertilizers and pesticides are manufactured which employ synthetic lignin sulfonates, the long-term effects of such surfactants are not known or reported. Further, the sulfur atoms are introduced in irregular pattern in lignin sulfonates leading to sulfonated intermediates which are unable to enter the central metabolic pathways thereby restricting the biodegradation of lignin sulfonates. In addition, the high sulfur content of lignosulfonate can negatively affect the microbial metabolism, thereby hindering lignin degradation. (Asina et. al., Microbial treatment of industrial lignin Successes, problems and challenges, 2017; Asina, Fnu, “Biodegradation of Lignin By Fungi, Bacteria And Laccases” (2016). Theses and Dissertations. 1864.)

Therefore, there is a need for fertilizer products or agricultural products that are devoid of synthetic adjuvants like lignin sulphonates, naphthalene lignin sulphonates etc. and are derived from natural or from sources that are certified as organic. The use and application of the natural (organic) products needs to be improved in order to provide an economical result in terms of yield, plant growth, vitality and vigor to the farmer and also reduce the burden on the environment.

While the prior art(s) teaches that it is essential to use synthetic surfactants to make water dispersible granules of sulphur in order to achieve a well dispersing and suspending product, the inventors have for the first time determined that the composition of the present invention can render water dispersible granules of sulphur without the use of synthetic surfactants. The problem is even more pronounced, when water dispersible granules of sulphur are made at a higher concentration and a lower particle size. Surfactants are needed to coat a much larger surface area of sulphur particles which need to be suspended and dispersed.

It is therefore surprising that inventors have made a composition of water dispersible granules of elemental sulphur with a fine particle size distribution, which does not use synthetic surfactants, but in fact uses natural materials which provide various other benefits to the soil and the plant ecosystem. The composition of the present invention was found to aid in the correction of soil pH and additionally support microbial action thereby facilitating the availability of elemental sulphur in the form that can be assimilated by the plants.

Therefore, embodiments of the present invention provide an organic agricultural composition that not only eliminates the associated drawbacks as noted in the preceding paragraphs, but also provides a superior composition which is otherwise difficult to achieve in a cost-effective manner.

Therefore, embodiments of the present invention provide an organic agricultural composition that exhibits superior physical characteristics such as suspensibility, dispersibility, wettability, improved viscosity and stability towards heat, light, temperature, and caking. The organic agricultural composition also demonstrates superior performance under accelerated storage conditions.

Therefore, embodiments of the present invention provide an organic agricultural composition which is economical, biodegradable and environment friendly. Further, the organic agricultural composition of the present invention comprising elemental sulfur and at least one hydrocolloid does not leave any chemical residue in the environment, and helps improve the fertility of soil and making the plants strong from the inside.

Thus, no specific organic agricultural composition comprising specific combination of elemental sulphur and at least one hydrocolloid, wherein the hydrocolloid has a viscosity of ≤400 cps at ≤30% (w/w) aqueous dispersion of the hydrocolloid; wherein the composition is in the form of granules or suspension is known or available. The agricultural composition is organic in nature and addresses the drawbacks discussed above with the known compositions.

Also, no process for preparing organic agricultural composition comprising combination of elemental sulphur and at least one hydrocolloid; wherein the hydrocolloid has a viscosity of ≤400 cps at ≤30% (w/w) aqueous dispersion of the hydrocolloid; wherein the composition is in the form of granules or suspension is known or available.

### 3. SUMMARY OF THE INVENTION

The invention relates to an organic agricultural composition, comprising elemental sulphur and at least one hydrocolloid; wherein the hydrocolloid has a viscosity of ≤400 cps at ≤30% (w/w) aqueous dispersion of the hydrocolloid; wherein the composition comprises particles in the size range of 0.1 micron to 25 microns. The organic agricultural composition is in the form of granules or suspension.

The invention also relates to a process for preparing an organic agricultural composition comprising elemental sulphur, and at least one hydrocolloid; wherein the hydrocolloid has a viscosity of ≤400 cps at ≤30% (w/w) aqueous dispersion of the hydrocolloid; wherein the composition is in the form of granules or suspension.

The process of preparing the water dispersible granular organic agricultural composition, comprises:
a. milling a blend of elemental sulphur, water and at least one hydrocolloid to obtain a slurry or wet mix; wherein the hydrocolloid has a viscosity of ≤400 cps at ≤30% (w/w) aqueous dispersion of the hydrocolloid to a particle size of 0.1 μ-25μ; and
b. drying the wet mix to obtain the water dispersible granular composition;

wherein the granules of the composition comprise of granules in size range of 0.1 to 2.5 mm.

The process of preparing the spheronised granular organic agricultural composition, comprises:
a. milling blend of elemental sulphur, water and at least one hydrocolloid to obtain a slurry or wet mix; wherein the hydrocolloid has a viscosity of ≤400 cps at ≤30% (w/w) aqueous dispersion of the hydrocolloid to a particle size of 0.1μ-25μ;
b. drying the wet mix to obtain the water dispersible granular composition;

wherein the granules of the composition comprise of granules in size range of 0.1 to 2.5 mm; and
c. water is added to the dry powder and the mixture is blended to obtain a wet mass, which is then extruded through an extruder to obtain the extruded granules in a size range of 0.1 mm to 6 mm; or
   agglomerating the wet mix or dry powder obtained in step (b) in an agglomerator to obtain granular composition in a size range of 0.1 mm to 6 mm.

The process of preparation of the organic agricultural suspension, comprising:
a. homogenizing mixture of elemental sulphur, a liquid vehicle and at least one hydrocolloid; wherein the hydrocolloid has a viscosity of ≤400 cps at ≤30% (w/w) aqueous dispersion of the hydrocolloid; and
b. wet milling the obtained suspension to provide composition with a particle size range of 0.1 micron to 25 microns.

### 4. DETAILED DESCRIPTION OF THE INVENTION

In describing the embodiment of the invention, specific terminology is chosen for the sake of clarity. However, it is not intended that the invention be limited to the specific terms so selected and it is to be understood that such specific terms include all technical equivalents that operate in a similar manner to accomplish a similar purpose. It is understood that any numerical range recited herein is intended to include all subranges subsumed. Also, unless denoted otherwise percentage of components in a composition are presented as weight percent.

The terms “a” or “an”, as used herein, are defined as one or more than one. The terms “including” and/or “having”, as used herein, are defined as comprising (i.e., open language).

Granules refers mainly to water dispersible granules, extruded granules or spheronised granules or pellets.

As described herein, “GR” refers to extruded granules or spheronised granules or pellets. The spheronised granules also refers to broadcast granules.

A water dispersible granule is defined as a formulation which disperses or dissolves readily when added to water to give a fine particle suspension. As described herein, “WG” or “WDG” refers to water dispersible granules.

An organic agricultural suspension encompasses, “aqueous suspension” or aqueous dispersion” or “suspension concentrate (SC)” or a “suspo-emulsion” or a ‘liquid suspension” composition. A suspension is defined as composition wherein solid particles are dispersed or suspended in a liquid. The liquid as a vehicle can be water and/or a water miscible solvent. The water miscible solvent is environmentally safe.

Organic agricultural composition is defined as a composition wherein, the composition comprises ingredients of natural origin or ingredients that are certifiable as organic.

The term ‘Elemental Sulphur’ used in the composition refers to elemental sulphur) (S°). The term includes allotropes of elemental sulfur such as plastic (amorphous) sulfur, monoclinic sulfur, rhombic sulfur composed of S8 molecules, and other ring molecules such as S7 and S12. The term also comprises sulphur produced through processing and refining of petrochemicals. The term also comprises ‘biosulfur’. The term also comprises elemental Sulphur produced through microbial processes.

The term ‘Hydrocolloid’ used in the composition refers to substances with affinity to water and also encompasses ‘gum’. The hydrocolloids used in the composition are water-binding colloids of natural origin including botanical, animal, or microbial origin.

Hydrocolloids are long chain polymers of polysaccharides characterised by their property of forming viscous dispersions and/or gels when dispersed in water. According to an embodiment, the hydrocolloids are a heterogeneous group of polysaccharides and proteins. Hydrocolloids are known in the art for being used as gelling agents, thickeners or stabilizers in healthcare, personal care or food industry.

Although the use of hydrocolloids as gelling agents, thickeners or stabilizers are known in the art, it was surprisingly determined by the inventors that the hydrocolloid having a viscosity of ≤400 cps at ≤30% (w/w) aqueous dispersion of the hydrocolloid, when combined with elemental sulphur exhibited unexpected synergistic effect.

Surprisingly, the inventors of the present application determined that the elemental sulphur when combined with at least one hydrocolloid with a viscosity of ≤400 cps at ≤30% (w/w) aqueous dispersion of the hydrocolloid, in an effective amount at a specific particle size is synergistic in nature, demonstrates excellent suspensibility, dispersibility in water and soil moisture, and thereby provides excellent field efficacy.

The inventors of the present application also determined that elemental sulphur when combined with at least one hydrocolloid with a viscosity of ≤400 cps at ≤30% (w/w) aqueous dispersion of the hydrocolloid in an effective amount at a specific particle size demonstrates excellent conversion of sulphur to its sulphate form to be available for uptake by the plants and which delivers sulphur uniformly and effectively to the soil and the plant, and hence does not need to be applied in advance or as an additional application and can be applied with ongoing applications.

It has surprisingly been found that loading of sulphur at an effective amount in combination with at least one hydrocolloid helped reduce the dependency on chemical adjuvants and excipients, further reducing toxicity caused to environment and humans, and avoid subsequent use of chemicals, and promote better plant health and yield.

It has surprisingly been found that when hydrocolloid with a viscosity of ≤400 cps at ≤30% (w/w) aqueous dispersion of the hydrocolloid is used in an effective amount with specific concentration of elemental sulphur besides providing binding, gelling or thickening properties, exhibited unexpected improvement in dispersibility, suspensibility and emulsifying properties of the composition, thereby obviating the use of chemical agents such as dispersing agents, wetting agents, chemical surfactants and emulsifying agents. Further, the inventors also found that the hydrocolloid provides stable structure to the composition and prevents sedimentation of the elemental sulphur particles after prolonged storage.

The inventors of the present invention found that hydrocolloids with viscosity of ≤400 cps at ≤30% aqueous dispersion for granular organic agricultural composition are selected in such a way that the hydrocolloid wets sulphur but does not form a viscous gel in water. For example, hydrocolloids like Xanthan gum, Almond gum and Katira gum cannot be used for the granular organic composition as it forms viscous gel in water at a concentration of 0.1% and does not wet sulphur. Also, hydrocolloids such as Gellan gum and Dammar gum cannot be used for the granular organic composition as it does not wet sulphur.

Further, the inventors also found that the granular organic agricultural composition provides excellent suspensibility and dispersibility of the sulphur particles in water when the hydrocolloid has a viscosity of ≤400 cps at ≤30% aqueous dispersion.

Elemental Sulphur is an essential active ingredient present in the organic agricultural composition and used in a concentration of about 60% w/w to 95% w/w of the total composition in combination with at least one hydrocolloid in a concentration of 0.1% to 40% w/w of the total composition which provides a more sustainable and ecological approach in agriculture for crop protection and nutrition; wherein the hydrocolloid has a viscosity of ≤400 cps at ≤30% (w/w) aqueous dispersion of the hydrocolloid. Further, the combination of at least one hydrocolloid with elemental sulphur attributed to enhance the role of sulphur as rectifier of certain structural characteristics of the soil, including in particular its pH and thereby shifts the pH of the soil towards neutral or acidic values for alkaline soils. The correction of pH value helps increase the oxidation of sulphur to sulphate form and thereby helps in better uptake of sulphur by plants.

In addition to the nutritional aspect of the composition of the present invention, the inventors surprisingly determined that the composition comprising elemental sulphur and at least one hydrocolloid in an effective amount in the form of suspension or granules provides excellent fungicidal and pest control and improves yield when the particles in the composition are present in the size range of 0.1 micron to 25 microns; wherein the hydrocolloid has a viscosity of ≤400 cps at ≤30% (w/w) aqueous dispersion of the hydrocolloid.

The inventors found that the composition of the present invention provides a stable organic ecological product which is a combination of elemental sulphur and at least one hydrocolloid in an effective amount. The composition is superior in nature on account of excellent suspensibility and dispersibility of the particles when the granules are immersed in water. As a consequence, the product does not exhibit clogging of nozzles which is seen in powder-based compositions or even conventional compositions that employ chemical adjuvants like lignin sulphonates.

The inventors have surprisingly found, in addition to eliminating synthetic chemical adjuvants and surfactants, the composition of the present invention also supports soil microbial activity, enhances the nutritional value of soil, and consequently, it improves and enhances the crop health.

Further, the inventors found that the composition of the present invention containing the natural product, hydrocolloid, is safe for environment, humans and animals. Consequently, the composition eliminates the residual effects and toxicity problem posed by the use of the conventional chemical adjuvants and surfactants.

The inventors also found that the agricultural composition in the form of suspension or granules comprising particles with a size in the range of 0.1 micron to 25 micron enhances the physical nature of the formulation by providing improved suspensibility, dispersibility, viscosity, instant dispersion of elemental sulphur on application via soil or foliar route which provides effective control of pest and disease occurrence. The fine particle size of the composition in turn increases the surface area of sulphur particles and also enables the product to cover wider surface area thus enabling bio-effectiveness at a substantially lower dosage.

Thus, the present invention relates to an organic agricultural composition comprising elemental sulphur, and at least one hydrocolloid. The hydrocolloid has viscosity of equal to or less than 400 cps at ≤30% (w/w) aqueous dispersion of the hydrocolloid.

The hydrocolloid used in the organic agricultural composition is selected such that the aqueous dispersion of the hydrocolloid at a concentration of ≤30% (w/w) has a viscosity of less than or equal to 400 cps. For instance, the hydrocolloid is selected such that when 30 grams of the hydrocolloid is dispersed in 70 grams of water, the dispersion has a viscosity of equal to or less than 400 cps. The viscosity of hydrocolloids at ≤30% (w/w) aqueous dispersion of the hydrocolloid can be measured by Brookfield viscometer for instance. The inventors also found that the composition of elemental sulphur with hydrocolloids at a concentration of ≤30% (w/w) having viscosity of less than or equal to 400 cps does not result in gelation or formation of a sticky mass during milling. As a consequence, the milled composition can be dried to obtain agglomerated particles i.e. water dispersible granules.

The hydrocolloids used in the organic agricultural composition are water-binding colloids of natural origin including botanical, animal, or microbial origin.

The hydrocolloid used in the organic agricultural composition can be an anionic, cationic, non-ionic, amphoteric or a hydrophobic hydrocolloid.

The hydrocolloid used in the organic agricultural composition can also possess emulsification properties.

According to an embodiment, the hydrocolloids have the ability to reduce the surface tension of water. According to an embodiment, the hydrocolloids have the ability to enhance the wettability of sulphur.

According to an embodiment, the hydrocolloids comprises gum arabic, gum karaya, gum ghatti (gum dhawada), larch gum, collagen (fish), Albizia gum, Abelmoschus gum, Bhara gum, Cashew gum, Cordio gum, Grewia gum, Hakea gum, Khaya gum, Katira gum, Kondagogu gum, Leucaena, seed gum, Malva nut gum, Mucuna gum, Moringa gum, Neem gum, Sesbanic gum, or mixture thereof. Preferably, the hydrocolloid is an anionic hydrocolloid selected from gum arabic, gum karaya, gum ghatti, neem gum, moringa gum or mixture thereof.

The organic agricultural composition comprises particles in the size range of 0.1 micron to 25 microns.

The organic agricultural composition is in the form of granules or suspension.

The granular organic agricultural composition is in the form of either water dispersible granules, extruded granules, spheronised granules or pellets.

The granular organic agricultural composition has granules in the size range of 0.1 mm to 6 mm which disperses into particles in the size range of 0.1 micron to 25 microns.

According to an embodiment, wherein the organic agricultural composition is in the form of granules, the composition comprises elemental sulphur in the range of 60% w/w to 95% w/w of the total composition, and at least one hydrocolloid in the range of 0.1% w/w to 40% w/w of the total composition; wherein the hydrocolloid has a viscosity of ≤400 cps at ≤30% (w/w) aqueous dispersion of the hydrocolloid.

According to a further embodiment, the elemental sulphur is present in the range of 60% w/w to 90% w/w of the total composition. According to a further embodiment, elemental sulphur is present in the range of 60% w/w to 80% w/w of the total composition. According to a further embodiment, elemental sulphur is present in the range of 60% w/w to 70% w/w of the total composition.

According to a further embodiment, at least one hydrocolloid is present in the range of 0.1% w/w to 40% w/w of the total composition. According to a further embodiment, at least one hydrocolloid is present in the range of 0.1% w/w to 30% w/w of the total composition. According to a further embodiment, at least one hydrocolloid is present in the range of 0.1% w/w to 20% w/w of the total composition. According to a further embodiment, at least one hydrocolloid is present in the range of 0.1% w/w to 10% w/w of the total composition.

According to a further embodiment, the hydrocolloid has a viscosity of ≤400 cps at ≤30% (w/w) aqueous dispersion of the hydrocolloid. According to a further embodiment, the hydrocolloid has a viscosity of ≤300 cps at ≤30% (w/w) aqueous dispersion of the hydrocolloid. According to a further embodiment, the hydrocolloid has a viscosity of ≤200 cps at ≤30% (w/w) aqueous dispersion of the hydrocolloid. According to a further embodiment, the hydrocolloid has a viscosity of ≤100 cps at ≤30% (w/w) aqueous dispersion of the hydrocolloid.

According to an embodiment, wherein the organic agricultural composition is in the form of suspension, the composition comprises elemental sulphur in the range of 40% w/w to 70% w/w of the total composition, and at least one hydrocolloid in the range of 0.1% w/w to 30% w/w of the total composition; wherein the hydrocolloid has a viscosity of ≤400 cps at ≤30% (w/w) aqueous dispersion of the hydrocolloid.

According to a further embodiment, elemental sulphur is present in the range of 40% w/w to 70% w/w of the total composition. According to an embodiment, elemental sulphur is present in the range of 40% w/w to 65% w/w of the total composition. According to an embodiment, elemental sulphur is present in the range of 40% w/w to 60% w/w of the total composition. According to an embodiment, elemental sulphur is present in the range of 40% w/w to 50% w/w of the total composition.

According to a further embodiment, at least one hydrocolloid is present in the range of 0.1% w/w to 30% w/w of the total composition. According to a further embodiment, at least one hydrocolloid is present in the range of 0.1% w/w to 20% w/w of the total composition. According to a further embodiment, at least one hydrocolloid is present in the range of 0.1% w/w to 10% w/w of the total composition.

According to a further embodiment, the hydrocolloid has a viscosity of ≤400 cps at ≤30% (w/w) aqueous dispersion of the hydrocolloid. According to a further embodiment, the hydrocolloid has a viscosity of ≤300 cps at ≤30% (w/w) aqueous dispersion of the hydrocolloid. According to a further embodiment, the hydrocolloid has a viscosity of ≤200 cps at ≤30% (w/w) aqueous dispersion of the hydrocolloid. According to a further embodiment, the hydrocolloid has a viscosity of ≤100 cps at ≤30% (w/w) aqueous dispersion of the hydrocolloid.

According to an embodiment, the composition comprises particles in the size range of 0.1 micron to 25 microns. According to a further embodiment, the organic agricultural composition comprises particles in the size range of 0.1 microns to 20 microns. According to a further embodiment, the organic agricultural composition comprises particles in the size range of 0.1 micron to 15 microns. According to a further embodiment, the organic agricultural composition comprises particles in the size range of 0.1 microns to 10 microns.

According to an embodiment, the organic agricultural composition is in the form of spheronised granules, wherein the granules are in the size range of 0.1 to 6 mm, preferably in the size range of 0.1 to 5 mm, preferably in the size range of 0.1 to 4 mm, preferably in the size range of 0.1 to 3 mm, preferably in the size range of 0.1 to 2.5 mm. The granules disperse into particles in the size range of 0.1 micron to 25 microns.

According to an embodiment, the organic agricultural composition is in the form of water dispersible granules or extruded granules, wherein the granules are in the size range of 0.1 to 2.5 mm, preferably in the size range of 0.1 to 2 mm, preferably in the size range of 0.1 to 1.5 mm, preferably in the size range of 0.1 to 1 mm, preferably in the size range of 0.1 to 0.5 mm. The granules disperse into particles in the size range of 0.1 micron to 25 microns, preferably in the size range of 0.1 micron to 15 microns.

According to an embodiment, the organic agricultural composition further comprises at least one additional active ingredient in the range of 0.1-40% by weight of the total composition and is selected from biostimulants, plant growth regulator, pesticidal actives and/or fertilizer or mixtures thereof.

According to an embodiment, the plant growth promoter can further comprise humic acid, ascorbic acid, fulvic acid, lactic acid, oxalic acid, phytic acid, fumaric acid, gibberellins, auxins, citric acid or mixtures thereof. However, the above list of plant growth promoter is exemplary and not meant to limit the scope of the invention.

According to an embodiment, the organic agricultural composition can further comprise at least one agrochemically acceptable excipient selected from structuring agents, surfactants including organic surfactants, binders or binding agents, disintegrating agents, fillers or carriers or diluents, spreading agents, coating agents, buffers or pH adjusters or neutralizing agents, anticaking agents, antifoaming agents or defoamers, penetrants, preservatives, stabilizers, pigments, colorants, structuring agents, chelating or complexing or sequestering agents, anti-settling agents, thickeners, suspending agents or suspension aid agents, viscosity modifiers, tackifiers, humectants, rheology modifiers, sticking agents, anti-freezing agent or freeze point depressants, solvents, water soluble inerts and mixtures thereof. However, those skilled in the art will appreciate that it is possible to utilize additional agrochemically acceptable excipients without departing from the scope of the present invention.

According to an embodiment, the organic agricultural composition in the form of granules further comprises at least one agrochemical excipient selected from wetting agents, surfactant including organic surfactants, emulsifiers, wetting agents, dispersing agents, binders or fillers or carriers or diluent, disintegrating agent, buffer or pH adjuster or neutralizing agent, antifoaming agent, anti-settling agents, anticaking agent, penetrating agent, sticking agent, tackifier, pigments, colorants, stabilizers, water soluble inerts, and mixtures thereof. However, those skilled in the art will appreciate that it is possible to utilize additional agrochemically acceptable excipients without departing from the scope of the present invention.

According to an embodiment, the organic agricultural suspension further comprises at least one agrochemical excipient selected from one structuring agent, surfactants including organic surfactants, humectants, solvents, water miscible solvents, spreading agent, suspending agents or suspension aid or anti-settling, penetrating agent, sticking agents, drift reducing agents, preservatives, stabilizers, buffers or pH adjusters or neutralizing agents, antifreezing agent or freeze point depressants, antifoaming agents. However, those skilled in the art will appreciate that it is possible to utilize additional agrochemically acceptable excipients without departing from the scope of the present invention.

According to an embodiment, the agrochemically acceptable excipient is present in the range of from 0.05% w/w to 30% w/w of the total composition.

According to a further embodiment, the agrochemically acceptable excipient is present in an amount of 0.05% to 20% w/w of the total composition. According to a further embodiment, the agrochemically acceptable excipient is present in an amount of 0.05% to 10% w/w of the total composition. According to an embodiment, the agrochemically acceptable excipient is present in an amount of 0.05% to 1% w/w of the total composition.

According to an embodiment, the term ‘organic surfactant’ refers to surfactants that are of natural origin or are certifiable as organic.

According to a further embodiment, the organic surfactant further comprises saponins such as Shikakai, Horse-chestnut, Oat, Sugar beet (leaves), Quinoa, Chickpea, Saffron crocus, Soybean, Licorice, Ivy, Alfalfa, Chinese ginseng, American ginseng, Green pea, Milkwort, Primula, Quillaja bark (LATAM), Reetha, Soapwort, Sarsaparilla, Fenugreek, soap nut, aritha, or Yucca as an extract or powdered foul(thereof. However, the above list of organic surfactant and saponins are exemplary and not meant to limit the scope of the invention. Further, those skilled in the art will appreciate that it is possible to utilize other conventionally known organic surfactants without departing from the scope of the present invention. The organic surfactants are commercially manufactured and available through various companies.

According to a further embodiment, the composition can comprise natural diluents. According to a further embodiment, natural diluents can comprise water soluble substances. For example, natural diluents comprise water soluble minerals or salts such as sulphates of sodium or potassium, or sodium chloride, or potassium chloride.

According to an embodiment, the binding agents or binders which are used in the organic agricultural composition, comprises one or more of lactose, water soluble cellulose derivatives, Starch, dextrins, bentonite, carbohydrates such as monosaccharides, disaccharides, oligosaccharides and polysaccharides, clays, kaolin clay, attapulgite clay their derivatives and combinations thereof. However, those skilled in the art will appreciate that it is possible to utilize different binding agents without departing from the scope of the present invention. The binding agents are organic in nature or certifiable as organic and are commercially manufactured and available through various companies.

According to an embodiment, the carriers which are used in the organic agricultural composition include, but are not limited to one or more of solid carriers or fillers or diluents. According to another embodiment, the carriers include mineral carriers, plant carriers, water-soluble carriers. However, those skilled in the art will appreciate that it is possible to utilize different carriers without departing from the scope of the present invention. The carriers are commercially manufactured and available through various companies.

The solid carriers include clay such as bentonite, clay, dolomite, kaolin, diatomaceous silicas, talc, natural silicates, starch, modified starch (Pineflow, available from Matsutani Chemical industry Co., Ltd.), plant carriers such as cellulose, starch, sucrose, Lactose, maltodextrin and dextrin. Water insoluble carriers include, but not limited to clays, microcrystalline cellulose, volcanic ash, diatomaceous earth, soap stone, starch. However, those skilled in the art will appreciate that it is possible to utilize different solid carriers without departing from the scope of the present invention. The solid carriers are commercially manufactured and available through various companies.

According to an embodiment, the anticaking agents which are used in organic agricultural composition include, but are not limited to one or more of silica, Perlite, Mica, Talc, soapstone, clays, ester gum, or derivatives thereof. However, those skilled in the art will appreciate that it is possible to utilize different anti-caking agents without departing from the scope of the present invention. The anti-caking agents are commercially manufactured and available through various companies.

According to an embodiment, the antifoaming agents or defoamers which are used in the composition include, but not limited to one or more of silica, silicone dioxide, vegetable oils, petroleum oils, paraffin oil, or derivatives thereof. However, those skilled in the art will appreciate that it is possible to utilize other conventionally known antifoaming agents without departing from the scope of the present invention. The antifoaming agents are commercially manufactured and available through various companies.

According to an embodiment, the sticking agents which are used in the composition include, but not limited to one or more of mineral oils, vegetable oils, petroleum oil, silicone oils, emulsifiers, fish oil or fatty acid soaps or emulsified vegetable oil, cellulose derivatives, natural polymers like xanthan gum. However, those skilled in the art will appreciate that it is possible to utilize other conventionally known sticking agents without departing from the scope of the present invention.

According to an embodiment, the preservatives which are used in the organic agricultural composition include but not limited to, one or more of bactericides, anti-fungal agents, biocides, anti-microbial agents, and antioxidant. Non-limiting examples of preservatives include one or more of Potassium Sorbate, Potassium Benzoate, sodium benzoate, paraben, salts or derivatives thereof. However, those skilled in the art will appreciate that it is possible to utilize other conventionally known preservatives without departing from the scope of the present invention. The preservatives are commercially manufactured and available through various companies.

According to an embodiment, the structuring agents which are used in the organic agricultural composition include, but not limited to one or more of thickeners, viscosity modifiers, tackifiers, suspension aids, rheological modifiers or anti-settling agents. The structuring agents comprises one or more of xanthan gum, metal silicates, methylcellulose, polysaccharide, alkaline earth metal silicate, bentonite, attapulgite, kaolin or polyvinyl alcohol. The structuring agents are commercially manufactured and available through various companies. However, those skilled in the art will appreciate that it is possible to utilize other conventionally known structuring agents without departing from the scope of the present invention.

According to an embodiment, the antifreezing agents or freezing point depressants used in the aqueous suspension composition include, but are not limited to one or more of polyhydric alcohols such as ethylene glycol, diethylene glycol, propylene glycol, glycerol, glycol ethers, glycol monoethers, carbohydrates such as fructose, galactose, sucrose, lactose, maltose, xylose, arabinose, trehalose, raffinose or derivatives thereof. However, those skilled in the art will appreciate that it is possible to utilize different antifreezing agents without departing from the scope of the present invention. The antifreezing agents are commercially manufactured and available through various companies.

According to an embodiment, the chelating or complexing or sequestering agents which are used in the aqueous suspension composition include, but not limited to one or more of α-hydroxy acids, such as citric acid; fulvic acid, cyclodextrin, humic acid. However, those skilled in the art will appreciate that it is possible to utilize other chelating or complexing or sequestering agents without departing from the scope of the present invention. The chelating or complexing or sequestering agents are commercially manufactured and available through various companies.

According to an embodiment, the penetrant which is used in the aqueous suspension composition include, but not limited to one or more of alcohol, glycol, etc. However, those skilled in the art will appreciate that it is possible to utilize different penetrants without departing from the scope of the present invention. The penetrants are commercially manufactured and available through various companies.

According to an embodiment, the humectant is selected from, but not limited to one or more of propylene glycol, ethylene glycol, glycerol, and the like. However, those skilled in the art will appreciate that it is possible to utilize other conventionally known humectants without departing from the scope of the present invention. The humectants are commercially manufactured and available through various companies.

It has been surprisingly found that the organic agricultural composition of the present invention has enhanced and improved physical properties of dispersibility, suspensibility, wettability, viscosity, pourability, and provides ease of handling and also reduces the loss of material while handling the product at the time of packaging as well as during field application.

Wettability is the condition or the state of being wettable and can be defined as the degree to which a solid is wetted by a liquid, measured by the force of adhesion between the solid and liquid phases. The wettability of the granular composition is measured using the Standard CIPAC Test MT-53 which describes a procedure for the determination of the time of complete wetting of wettable formulations. A weighed amount of the granular composition is dropped on water in a beaker from a specified height and the time for complete wetting was determined. According to another embodiment, the organic agricultural composition in the form of water dispersible granules or spheronised granules has wettability of less than 2 minutes.

The spheronised granular composition is formulated in a manner such that it is imparted with sufficient hardness which prevents the granules from crumbling during storage and transportation. The hardness exhibited by the granules can be estimated by hardness testers such as the ones provided by Shimadzu, Brinell Hardness (AKB-3000 Model), Mecmesin, Agilent, Vinsyst, Ametek, Erweka, Electrolab, Dr. Schleuniger's pharmatron and Rockwell. According to an embodiment, the hardness exhibited by the granules is at least 1 Newton.

According to an embodiment, the organic agricultural composition in the form of water dispersible granule or suspension passes the wet sieve retention test. The test is used to determine the amount of non-dispersible material in formulations that are applied as dispersions in water. The wet sieve retention value of the agrochemical composition in the form of suspension and granules is measured by using the Standard CIPAC Test MT-185 which describes a procedure for the measuring the amount of material retained on the sieve. A sample of the formulation is dispersed in water and the suspension formed is transferred to a sieve and washed. The amount of the material retained on the sieve is determined by drying and weighing

According to an embodiment, the organic agricultural composition in the form of water dispersible granule or suspension has a wet sieve retention value on a 75-micron sieve of less than 0.5%. According to an embodiment, the organic agricultural composition has a wet sieve retention value on a 75-micron sieve of less than 0.2%. The wet sieve retention value of less than 0.5% indicate that the organic agricultural composition helps in easy application of the formulation preventing clogging of the nozzles or filter equipment.

According to an embodiment, the organic agricultural composition in the form of suspension does not sediment or settle on storage and is easily pourable. This property can be measured in terms of viscosity of the fluid which is a measure of its resistance to gradual deformation by shear stress or tensile stress.

According to an embodiment, viscosity of the liquid composition is determined as per CIPAC MT-192. A sample is transferred to a standard measuring system. The measurement is carried out under different shear conditions and the apparent viscosities are determined. During the test, the temperature of the liquid is kept constant. According to an embodiment, the organic agricultural composition has a viscosity at 25° C. of about 10 cps to about 3000 cps.

According to an embodiment, the suspension composition of the present invention is easily pourable. The pourability is the measure of percent of residue. According to an embodiment, the pourability of the organic agricultural composition is determined as per CIPAC MT-148.1 by allowing the suspension to stand for 24-hour and the amount remaining in the container after a standardized pouring procedure is determined. The container is rinsed and the amount then remaining is determined and the maximum residue in percent is calculated. According to a further embodiment, the pourability of the organic agricultural composition is less than 5% residue.

Dispersibility of the organic agricultural composition in the form of water dispersible or spheronised granule and suspension is a measure of percent dispersion. Dispersibility is calculated by the minimum percent dispersion. Dispersibility is defined as the ability of the granules to disperse upon addition to a liquid such as water or a solvent. Dispersibility of the granular composition of the present application, was determined as per the standard CIPAC test, MT 174. A known amount of the granular composition was added to a defined volume of water and mixed by stirring to form a suspension. After standing for a short period, the top nine-tenths are drawn off and the remaining tenth dried and determined gravimetrically. The method is virtually a shortened test of suspensibility and is appropriate for establishing the ease with which the granular composition dispersed uniformly in water.

According to an embodiment, the organic agricultural composition has a dispersibility of at least 30%.

According to an embodiment, the organic agricultural composition in the form of water dispersible granule exhibits almost instantaneous dispersion.

According to an embodiment, the organic agricultural composition in the form of spheronised granule makes the actives available instantaneously and also over a longer period which may extend throughout the crop cycle, providing an immediate and sustained release of actives eventually strengthening and protecting the crop at each and every stage of the crop cycle.

According to an embodiment, the organic agricultural composition in the form of granules or suspension exhibits good suspensibility. Suspensibility is defined as the amount of active ingredient suspended after a given time in a column of liquid, of stated height, expressed as a percentage of the amount of active ingredient in the original suspension. The water dispersible granules can be tested for suspensibility as per the CIPAC Handbook, “MT 184 Test for Suspensibility” whereby a suspension of known concentration of the composition in CIPAC Standard Water was prepared and placed in a prescribed measuring cylinder at a constant temperature, and allowed to remain undisturbed for a specified time. The top 9/10ths were drawn off and the remaining 1/10th was then assayed chemically, gravimetrically, or by solvent extraction, and the suspensibility was calculated. The suspensibility of the suspension is the amount of active ingredient suspended after a given time in a column of liquid, of stated height, expressed as a percentage of the amount of active ingredient in the original suspension. The suspensibility of suspension concentrate is determined as per CIPAC MT-161 by preparing 250 ml of diluted suspension, allowing it to stand in a measuring cylinder under defined conditions, and removing the top nine-tenths. The remaining tenth is then assayed chemically, gravimetrically or by solvent extraction, and the suspensibility is calculated.

According to an embodiment, the organic agricultural composition has a suspensibility of at least 30%.

According to an embodiment, the organic agricultural composition in the form of water dispersible granule or spheronised granule, suspension demonstrates superior stability in terms of suspensibility under accelerated storage condition (ATS). According to an embodiment, the organic agricultural composition demonstrates suspensibility of at least 30% under ATS.

According to an embodiment, the organic agricultural composition demonstrates superior stability towards heat, light, temperature and caking. The composition does not form a hard cake and exhibits enhanced stability even at extended storage under higher temperatures which in turn results in superior field performance. According to further embodiment, the stability exhibited by the organic agricultural composition is at least 6 months.

According to an embodiment, the present invention also relates to a process of preparing organic agricultural composition comprising elemental sulphur present and at least one hydrocolloid in the form of granules or suspension, wherein the composition has particles in the size range of 0.1 micron to 25 microns; wherein the hydrocolloid has viscosity of ≤400 cps at ≤30% (w/w) aqueous dispersion of the hydrocolloid.

According to an embodiment, the process of preparing organic agricultural composition in granular form, comprising elemental sulphur present in the range of 60% w/w to 95% w/w of the total composition, at least one hydrocolloid present in the range of 0.1% w/w to 40% w/w of the total composition; wherein the composition has particles in the size range of 0.1 micron to 25 microns; wherein the hydrocolloid has viscosity of ≤400 cps at ≤30% (w/w) aqueous dispersion of the hydrocolloid. The granular organic agricultural composition is in the form of either water dispersible granules, extruded granules, spheronised granules or pellets.

According to an embodiment, the process of preparing organic agricultural composition in the form of suspension, comprising elemental sulphur present in the range of 40% w/w to 70% w/w of the total composition, and at least one hydrocolloid present in the range of 0.1% w/w to 30% w/w of the total composition; wherein the composition has particles in the size range of 0.1 micron to 25 microns; wherein the hydrocolloid has viscosity of ≤400 cps at ≤30% (w/w) aqueous dispersion of the hydrocolloid.

According to another embodiment, the organic agricultural composition in the form of water dispersible granules or spheronised granules, is made by various techniques such as spray drying, fluidized bed granulation, pan granulation, pin agglomerator, spheronizer, freeze drying etc. The granules can also be extruded through the extruded to obtain extruded granules.

According to an embodiment, the process of preparing a water dispersible granular organic agricultural composition involves milling a blend of elemental sulphur, water and at least one hydrocolloid to obtain slurry or a wet mix. The wet mix obtained is then dried, for instance in a spray dryer, fluid bed dryer or any suitable granulating equipment, followed by sieving to remove the undersized and oversized granules to obtain water dispersible granules of the desired size if required. However, those skilled in the art will appreciate that it is possible to modify or alter or change the process or process parameters to obtain water dispersible granular composition without departing from the scope of the present invention. Water is added to the dry powder and the mixture is blended to obtain a wet mass, which is then extruded through an extruder to obtain the granules of desired size. The wet mass as referred herein also includes dough or paste. The granules can also be formed with hot melt extrusion. However, those skilled in the art will appreciate that it is possible to modify or alter or change the process or process parameters to obtain granular composition without departing from the scope of the present invention.

The granules obtained from the granulator can also be dried in open air or air-dried, to remove any residual moisture, if any. However, those skilled in the art will appreciate that it is possible to modify or alter or change the process or process parameters without departing from the scope of the present invention.

According to another embodiment, the invention further relates to the process for preparing the spheronised granules which involves milling a blend of elemental sulphur, water and at least one hydrocolloid to obtain slurry or a wet mix. The wet mix obtained is then dried, for instance in a spray dryer, fluid bed dryer or any suitable granulating equipment, followed by sieving to remove the undersized and oversized granules to obtain granules. The powder or the fine granules is further subjected to agglomeration in an agglomerator to obtain granules of size 0.1 mm to 6 mm. The agglomerator can include various equipments such as a disc pelletizer or pan granulator, pin agglomerator, spheronizer, or combinations thereof.

According to another embodiment, the invention relates to a process for preparing the suspension composition.

According to an embodiment, the invention relates to a process of preparation of the suspension organic agricultural composition, the process comprising: homogenizing mixture of elemental sulphur, liquid vehicle and at least one hydrocolloid to obtain a suspension; and wet milling the obtained suspension to provide composition with a particle size range of 0.1 micron to 25 microns; wherein the hydrocolloid has viscosity of ≤400 cps at ≤30% (w/w) aqueous dispersion of the hydrocolloid. The liquid vehicle is selected from water and/or a water miscible solvent. The water miscible solvent is environmentally safe.

According to an embodiment, the composition of the present invention is at least one of a pesticide composition, a crop protection composition, a fertilizer composition, a crop strengthener composition, a yield enhancer composition.

According to an embodiment, the invention also relates to a method of protecting the crop, controlling insect pest, improving the crop health and growth, enhancing the crop yield, strengthening the plant, increasing crop defense, the method comprising treating at least one of seed, crops, a plant, plant propagation material, locus, parts thereof or to the surrounding soil with effective amount of the organic agricultural composition of the present invention in the form of water dispersible granules or spheronised granules, suspension.

The composition is applied through a variety of methods. Methods of applying to the soil include any suitable method, which ensures that the composition penetrates the soil, for example nursery tray application, in furrow application, soil drenching, soil injection, drip irrigation, sprinkler irrigation, seed treatment, seed painting and such other methods. The composition also is applied in the form of a foliar spray.

The rates of application or the dosage of the composition depends on the type of use, the type of crops, or the specific active ingredients in the composition but is such that the active ingredient, is in an effective amount to provide the desired action (such as crop nutrition, crop protection, crop yield).

From the foregoing it will be observed that numerous modifications and variations can be effectuated without departing from the true spirit and scope of the novel concepts of the present invention. It is to be understood that no limitation with respect to the specific embodiments illustrated is intended or should be inferred.

### PREPARATION EXAMPLES

The following examples illustrate the basic methodology and versatility of the composition of the invention. Hydrocolloid exemplified in the preparatory examples can be replaced by any other hydrocolloid thereof. It should be noted that this invention is not limited to these exemplifications.

A. Water Dispersible Granular Composition of Elemental Sulphur and Hydrocolloid.

### Example 1: Water Dispersible Granular Composition of 80% (w/w) Elemental Sulphur and 10% (w/w) Gum Arabic and 10% (w/w) Gum Ghatti

Water dispersible granular composition was prepared by blending 81 parts of elemental sulphur, 10 part of gum arabic and 10 parts of gum ghatti to obtain a blend. The blend obtained was mixed with water in suitable mixing equipment and milled to form a slurry or wet mix.

The wet milled slurry obtained was spray dried at an inlet temperature less than 150° C. and outlet temperature less than 70° C. to get a granular powder. The composition had the following particle size distribution: DIO less than 1.0 microns; D50 less than 2.5 microns and D90 less than 10.0 microns. The granule size of the composition was in the range of 1-2 mm. The composition had a dispersibility of 85%, a suspensibility of 90.3%, wet sieve retention value of 0.5, wettability of less than 60 sec. The composition further demonstrated dispersibility of 82.7% and suspensibility of about 88.4% under accelerated storage condition

### Example 2: Water Dispersible Granular Composition of 90% (w/w) Elemental Sulphur and 4% (w/w) Gum Ghatti

Water dispersible granular composition was prepared by blending 91 parts of elemental sulphur, 4 part of gum ghatti and 6 parts of fulvic acid to obtain a blend. The blend obtained was mixed with water in suitable mixing equipment and milled to form a slurry or wet mix.

The wet milled slurry obtained was spray dried at an inlet temperature less than 150° C. and outlet temperature less than 70° C. to get a granular powder. The composition had the following particle size distribution: D10 less than 1.0 microns; D50 less than 2.5 microns and D90 less than 5 microns. The granule size of the composition was in the range of 1-2 mm. The composition had a dispersibility of 85%, a suspensibility of 90%, a wet sieve retention value of 0.5, wettability of less than 60 sec. The composition further demonstrated dispersibility of 85% and suspensibility of about 90% under accelerated storage condition

The exemplary combinations of the water dispersible granular composition prepared as per example 1 is tabulated below:

| | Conc. | | | | | | | | | | | | | | |
|---|---|---|---|---|---|---|---|---|---|---|---|---|---|---|---|
| | of | | | | | | | | Particle size | | | | | ATS | |
| Ex. | Sulphur | Conc. of Hydrocolloid (%) | | | | | Excipient | | distribution | | | SS | DP | SS | DP |
| no. | (%) | GA | GK | GG | NG | MG | (%) | Excipient name | D10 | D50 | D90 | (%) | (%) | (%) | (%) |
| 3 | 60 | 10 | — | 10 | — | — | 20 | Clay (10%), Lactose | 0.58 | 2.24 | 4.48 | 91.2 | 88.5 | 87.2 | 81.1 |
| | | | | | | | | (10%) | | | | | | | |
| 4 | 70 | 10 | 15 | — | — | — | 5 | 5% Fulvic acid | 0.85 | 3.45 | 8.21 | 90.3 | 84.6 | 87.1 | 82.6 |
| 5 | 82 | 18 | — | — | — | — | 0 | — | 0.53 | 2.45 | 4.92 | 88.9 | 86.2 | 85.4 | 82.5 |
| 6 | 82 | — | 8 | — | — | — | 10 | Sodium chloride | 0.62 | 2.56 | 5.12 | 88.7 | 84.1 | 86.1 | 82.1 |
| | | | | | | | | (3%), Clay (7%) | | | | | | | |
| 7 | 82 | — | — | 8 | — | — | 10 | Starch (5%), Kaolin | 0.42 | 2.14 | 4.35 | 87.2 | 83.9 | 85.4 | 80.2 |
| | | | | | | | | (5%) | | | | | | | |
| 8 | 82 | — | — | — | 8 | — | 10 | Maltodextrin (4%), | 0.71 | 2.67 | 5.34 | 86.2 | 83.6 | 84.5 | 81.2 |
| | | | | | | | | Kaolin (6%) | | | | | | | |
| 9 | 82 | — | — | — | — | 8 | 10 | Potassium sulphate | 0.85 | 2.94 | 5.81 | 87 | 83.8 | 85 | 81.2 |
| | | | | | | | | (4%), Kaolin (6%) | | | | | | | |
| 10 | 92 | 8 | — | — | — | — | 0 | — | 0.49 | 2.27 | 4.51 | 86.3 | 84.4 | 84.1 | 81 |
| 11 | 92 | — | — | 8 | — | — | 0 | — | 0.46 | 2.31 | 4.63 | 85.4 | 83.8 | 82.1 | 80 |
| 12 | 95 | — | 5 | — | — | — | 0 | — | 0.74 | 2.69 | 5.45 | 83.1 | 82.4 | 80.4 | 79.6 |

GA = Gum arabic,
GK = Gum karaya;
GG = Gum Ghatti;
NG = Neem Gum;
MG = Moringa Gum;
ATS = Accelerated Storage Condition;
SS = Suspensibility;
DP = Dispersibility

B. Liquid Suspension Compositions of Elemental Sulphur and Hydrocolloid

### Example 13: Liquid Suspension Composition of 50% Elemental Sulphur and 20% Gum Arabic

Liquid suspension composition was prepared by mixing 20 parts of gum arabic, 51 parts of elemental sulphur, 5 parts of glycerol, 0.5 parts of potassium sorbate, 0.5 parts of sodium benzoate, 0.1 parts of xanthan gum and water (quantity sufficient) and homogenized by feeding them into a vessel provided with stirring facilities until the total mixture was homogeneous. Subsequently, the suspension obtained was passed through the wet mill to obtain a suspension concentrate with less than 20 microns particle size. The composition had particle size distribution of about D10 less than 0.5 microns; D50 less than 2.5 microns and D90 less than 5.0 microns. The sample had suspensibility of about 94.8%, viscosity of about 800 cps. The composition had suspensibility of about 90.0 and viscosity of about 950 cps under accelerated storage condition.

The exemplary combination of liquid suspension composition prepared as per example 15 is tabulated below:

| | Conc. | | | | | | | | | | | | | | | | | |
|---|---|---|---|---|---|---|---|---|---|---|---|---|---|---|---|---|---|---|
| | of | | | | | | Excipient (%) | | | | | Particle size | | | | | ATS | |
| Ex. | Sulphur | Conc. of Hydrocolloid (%) | | | | | | Potassium | Sodium | | | distribution | | | SS | VC | SS | VC |
| no. | (%) | GA | GK | GG | NG | MG | Glycerol | sorbate | benzoate | G-1 | Water | D10 | D50 | D90 | (%) | (cps) | (%) | (cps) |
| 14 | 40 | 10 | 5 | 5 | — | — | 5 | 0.5 | 0.5 | 1 | Q.S | 0.25 | 1.25 | 3.25 | 92.6 | 620 | 92.6 | 665 |
| 15 | 62 | 2 | — | 2 | — | — | 5 | 0.5 | 0.5 | 1 | Q.S | 018 | 0.95 | 2.85 | 88.6 | 760 | 88.5 | 800 |

GA = Gum arabic,
GK = Gum karaya;
GG = Gum Ghatti;
NG = Neem Gum;
MG = Moringa Gum
ATS = Accelerated Storage Condition;
SS = Suspensibility;
VC: Viscosity;
Q.S: quantity sufficient;
G-1: Xanthan gum

Bio-Efficacy Data:

Field Trial Data 1: To study effect of elemental sulphur and hydrocolloids on Round Melon and Chick pea

The effectiveness of combination of sulphur with hydrocolloids was evaluated in the form of water dispersible granules (WDG) and suspension concentrates (SC), in comparison to application of commercially available or conventional sulphur formulations and an untreated control.

The efficacy trials conducted in India using stand-alone treatments of sulphur and hydrocolloids were done in accordance with standard recommended dosages for active ingredients. However, it may be noted that the recommended dosages for each active ingredient may vary as per recommendations in a particular country, soil condition, weather condition and disease incidence. The treatments were carried out following randomized block design (RBD) and keeping all agronomic practices uniform.

The field trials were carried out to see the effect of combination of elemental sulphur and hydrocolloids on Round melon (Hybrid Tinda) and Chick Pea (Bengal Gram). The trial was laid out as described below including untreated control, and replicated thrice. The crops in trial field was raised following good agricultural practice.

| Details of experiment | Hybrid Tinda | Chick Pea |
|---|---|---|
| Trial Location | Indore, Madhya | Indore, Madhya |
| | Pradesh | Pradesh |
| Experiment season | April 2021 | April 2021 |
| Trial Design | RBD | RBD |
| Replications | 03 | 03 |
| Plot size | 100 m² | 30 m² |
| Date of 1^{st} application | Apr. 7, 2021 | Apr. 7, 2021 |
| Crop Age/Stage | Days after | Days after |
| | sowing (DAS) | sowing (DAS) |
| Method of application | Basal application | Basal application |

TABLE 1
Effect of combination of elemental sulphur and hydrocolloid on plant growth, yield over control in Round Melon

| | | | | | | | Total yield | | % Yield |
|---|---|---|---|---|---|---|---|---|---|
| | | Elemental | Plant height | | Number of | | kg/plot | | (q/acre) |
| | | Sulphur | (cm) at | | Branches/plants | | (05 | Total | increase |
| T. | | applied | 30 | 45 | 30 | 45 | Harvests | yield | over |
| No. | Composition | (g.a.i/acre) | DAS | DAS | DAS | DAS | picking) | q/Acre | Control |
| 1 | Elemental sulphur 90% | 2700 | 45.4 | 69.33 | 4.67 | 6.2 | 6.4 | 2.6 | 28.5 |
| | w/w + Gum arabic 10% | | | | | | | | |
| | w/w WG as per | | | | | | | | |
| | embodiment of the present | | | | | | | | |
| | invention @3 kg/acre | | | | | | | | |
| 2 | Fertis ® (Sulphur 90% w/w | 2700 | 44.6 | 68.87 | 4.53 | 6.27 | 5.9 | 2.41 | 18.67 |
| | WG) @3 kg/acre | | | | | | | | |
| 3 | Elemental sulphur 55% | 2700 | 55 | 78 | 5.2 | 8.3 | 6.1 | 2.47 | 22.5 |
| | w/w (800 g/L) + Gum | | | | | | | | |
| | arabic 8% w/w SC as per | | | | | | | | |
| | embodiment of the present | | | | | | | | |
| | invention @ 4.9 L/acre | | | | | | | | |
| 4 | Flosul ® SC (Sulphur | 2700 | 50 | 70 | 4.8 | 7.3 | 5.6 | 2.26 | 12.45 |
| | 800 g/L equivalent to | | | | | | | | |
| | 55% w/w) @ 4.9 L/acre | | | | | | | | |
| 5 | Untreated control | — | 45.03 | 66.13 | 4.6 | 6.13 | 4.98 | 2.01 | 0 |

It is observed from Table 1, that treatment 1 (T1) and treatment T3 (T3) showed improved yield of crops, plant height, and no. of branches/plant in Round Melon as compared to treatments T2 and T4, and untreated control. It is to be noted that the commercially available sulphur formulations used in the trial i.e. Fertis® WG and Flosul® SC have lignin sulphonates as the essential dispersing agent.

Further, Elemental sulphur 90%+Gum arabic 10% WDG (Treatment 1) and commercially available sulphur formulation Fertis® (Sulphur 90 WG) (Treatment 2) applied to Round Melon crop at a dose of 3 Kg/acre on the day of the sowing, exhibited about 28.51% and 18.67% increase respectively in yield over the control. The composition prepared as per embodiment of the present invention showed improved yield of crops as compared to the application of commercially available Sulphur formulation (Fertis and untreated plot. Further, the composition of the present invention exhibited 8.3% increase in total yield as compared to the yield obtained on application of commercially available Sulphur formulation (Fertis®).

Further, Treatment 3 (T3) prepared as per embodiment of the present invention and Treatment 4 (T4) commercially available Sulphur SC formulation (Flosul® SC 800 g/Lit) applied to Round Melon crop at a dose of 4.6 kg/acre on the day of the sowing, exhibited about 22.5% and 12.45% increase respectively in yield over the untreated control. The composition prepared as per embodiment of the present invention showed improved yield of round melon as compared to application of commercially available sulphur SC formulation (Flosul® SC) and untreated plot. Further, the composition of the present invention exhibited 8.92% increase in total yield as compared to the yield obtained on application of commercially available Sulphur formulation (Flosul® SC).

TABLE 2
Effect of combination of elemental sulphur and hydrocolloid on Chick Pea

| | | Elemental | | | | | % Yield |
|---|---|---|---|---|---|---|---|
| | | Sulphur | No. of | | Total | Grain | increase |
| T. | | applied | Pods | 1000 seed | Yield | yield | (Q/acre) |
| No | Composition | (gai/acre) | per plant | weight | (kg/plot) | (Q/acre) | over control |
| 1 | Elemental | 1800 | 47.67 | 645 | 3.42 | 4.61 | 23.47 |
| | Sulphur 60% | | | | | | |
| | (w/w) + Gum | | | | | | |
| | Ghatti 20% | | | | | | |
| | WDG as per | | | | | | |
| | embodiment of | | | | | | |
| | the present | | | | | | |
| | invention applied | | | | | | |
| | @ 3 kg/acre | | | | | | |
| 2 | Sulphur 60% | 1800 | 46.77 | 631 | 3.15 | 4.25 | 13.72 |
| | (w/w) WG | | | | | | |
| | prepared as per | | | | | | |
| | conventional | | | | | | |
| | method @ 3 | | | | | | |
| | kg/acre | | | | | | |
| 3 | Elemental | 1800 | 47.1 | 640 | 3.39 | 4.57 | 22.38 |
| | Sulphur 45% | | | | | | |
| | (w/w) + Gum | | | | | | |
| | Ghatti 20% (w/w) | | | | | | |
| | SC as per an | | | | | | |
| | embodiment of | | | | | | |
| | the invention | | | | | | |
| | @ 4 L/acre | | | | | | |
| 4 | Elemental | 1800 | 45.17 | 628 | 3.13 | 4.22 | 13.00 |
| | Sulphur | | | | | | |
| | 45%(w/w) | | | | | | |
| | prepared as per | | | | | | |
| | conventional | | | | | | |
| | method @ | | | | | | |
| | 4 L/acre | | | | | | |
| 5 | Untreated | — | 44 | 622 | 2.77 | 3.74 | — |

It is observed from Table 2, that treatment 1 (T1) and treatment T3 (T3) prepared as per the embodiment of the present invention showed increase in the number of pods, weight of 1000 seeds and yield as compared to treatment with sulphur prepared as per conventional methods (wherein lignin sulphonate is used as an essential dispersing agent) and untreated control.

Further, Elemental sulphur 60% w/w+Gum ghatti 20% w/w WDG prepared as per embodiment of the present invention (Treatment 1) and conventional Sulphur 60% w/w WDG formulation prepared with lignin sulphonate as dispersing agent applied to Chick pea crop at a dose of 3 Kg/acre on the day of the sowing, exhibited about 23.47% and 13.72% increase in yield respectively over untreated. Further, the composition of the present invention exhibited 8.57% increase in total yield as compared to the yield obtained on application of commercially available Sulphur formulation (Fertis®).

Further, Elemental sulphur 55% (800 g/L)+Gum arabic 8% SC (Treatment 3) and Sulphur 45% (w/w) SC prepared as per conventional method applied to Chick pea crop at a dose of 4 L/acre on the day of the sowing, exhibited about 22.38% and 13.00% increase in yield respectively over the control. Further, the composition of the present invention exhibited 8.63% increase in total yield as compared to the yield obtained on application of commercially available Sulphur formulation (Flosul® SC).

Thus, the composition prepared as per embodiment of the present invention showed improved yield of chick pea as compared to application of sulphur SC formulation prepared as per conventional methods by using lignin sulphonate as dispersing agent and untreated plot.

Experiment No. 1: Trial was conducted for the evaluation of the effect of the composition of the present invention on beneficial bacterial and fungal strains in soil for Azotobacter sp., and Trichoderma viride at different concentrations of the composition.

The sterile soil was inoculated with beneficial bacterial and fungal strains in soil for Azotobacter sp., and Trichoderma viride and treated with the composition of the present invention and conventional sulphur formulation prepared by using lignin sulphonate as dispersing agent.

TABLE 3
Effect of the organic agricultural composition of the present invention on
the beneficial bacterial and fungal strains in soil.

| | | Elemental | Cell Population (CFU/gm) | | | | | |
|---|---|---|---|---|---|---|---|---|
| | | Sulphur | Azotobacter sp. | | | Trichoderma viride | | |
| T. | | (gai/ | Day | Day | % | Day | Day | % |
| no. | Composition | acre) | 1 | 7 | Change | 1 | 7 | Change |
| T1 | Elemental | 2850 | 2.5 × 10⁷ | 3 × 10⁷ | 20 | 6 × 10⁶ | 2.9 × 10⁷ | 79 |
| | sulphur 95% + | | | | | | | |
| | Gum arabic | | | | | | | |
| | 5% WDG as | | | | | | | |
| | per | | | | | | | |
| | embodiment | | | | | | | |
| | of the present | | | | | | | |
| | invention @3 | | | | | | | |
| | kg/acre | | | | | | | |
| T2 | Conventional | 2850 | 2.6 × 10⁷ | 3 × 10⁷ | 15.4 | 6 × 10⁶ | 1.5 × 10⁷ | 60 |
| | Sulphur 95% | | | | | | | |
| | WG @3 | | | | | | | |
| | kg/acre | | | | | | | |
| T3 | Untreated | — | 2.3 × 10⁷ | 2.4 × 10⁷ | 4.35 | 3.5 × 10⁶ | 3.5 × 10⁶ | 0 |

It was noted that treatments T1 appeared to better support the growth of Trichoderma viride and Azotobacter sp. in soil as compared to the conventional sulphur 95% WG formulation prepared by using lignin sulphonate as dispersing agent.

Thus, the organic agricultural composition of the present invention in the form of water dispersible granules supports the growth of beneficial microorganisms.

From the foregoing, it will be observed that numerous modifications and variations can be effectuated without departing from the true spirit and scope of the novel concepts of the present invention. It is to be understood that no limitation with respect to the specific embodiments illustrated is intended or should be inferred.

1-18. (canceled)

19. An organic agricultural composition, comprising:
elemental sulphur; and
at least one hydrocolloid; wherein the hydrocolloid has a viscosity of less than 400 cps at 30% (w/w) aqueous dispersion of the hydrocolloid;
wherein the composition comprises particles in the size range of 0.1 micron to 25 microns.

20. The organic agricultural composition of claim 19, wherein the hydrocolloid comprises Gum arabic, Gum karaya, Gum ghatti (gum dhawada), Larch gum, collagen (fish), Albizia gum, Abelmoschus gum, Bhara gum, Cashew gum, Cordio gum, Grewia gum, Hakea gum, Khaya gum, Katira gum, Kondagogu gum, Leucaena, Seed gum, Malva nut gum, Mucuna gum, Moringa gum, Neem gum, Sesbanic gum, or mixture thereof.

21. The organic agricultural composition of claim 19, wherein the hydrocolloid is selected from gum arabic, gum karaya, gum ghatti, moringa gum, neem gum, or mixtures thereof.

22. The organic agricultural composition of claim 19, in the form of granules or liquid suspension.

23. The organic agricultural composition of claim 22, wherein the granules are water dispersible granules, spheronised granules, extruded granules, or pellets.

24. The organic agricultural composition of claim 19, wherein the composition in the form of granules comprises the elemental sulphur in the range of 60% w/w to 95% w/w of the total composition and at least one hydrocolloid in the range of 0.1% w/w to 40% w/w of the total composition; wherein the hydrocolloid has viscosity of less than 400 cps at 30% (w/w) aqueous dispersion of the hydrocolloid.

25. The organic agricultural composition of claim 19, wherein the composition in the form of liquid suspension comprises the elemental sulphur in the range of 40% w/w to 70% w/w of the total composition and at least one hydrocolloid in the range of 0.1% w/w to 30% w/w of the total composition; wherein the hydrocolloid has viscosity of less than 400 cps at 30% (w/w) aqueous dispersion of the hydrocolloid.

26. The organic agricultural composition of claim 19 in the form of granules, wherein the granules disperse into particles in the size range of 0.1 micron to 15 microns.

27. The organic agricultural composition of claim 19 in the form of granules, wherein a granule size is in the range of 0.1 mm to 6 mm.

28. The organic agricultural composition of claim 19 in the form of granules, wherein the granules are water dispersible granules, and wherein the water dispersible granules have granule size in the range of 0.1 mm to 2.5 mm.

29. The organic agricultural composition of claim 19, wherein suspensibility of the composition is at least 30%.

30. The organic agricultural composition of claim 19, wherein dispersibility of the composition is at least 30%.

31. The organic agricultural composition of claim 19, further comprising at least one additional active ingredient selected from biostimulants, plant growth regulator, pesticidal actives, fertilizer, or mixtures thereof.

32. The organic agricultural composition of claim 19, wherein the composition in the form of granules further comprises at least one agrochemically acceptable excipient is selected from wetting agents, surfactants including organic surfactants, emulsifiers, wetting agents, dispersing agents, binders or fillers or carriers or diluent, disintegrating agent, buffer or pH adjuster or neutralizing agent, antifoaming agent, anti-settling agents, anticaking agent, penetrating agent, sticking agent, tackifier, pigments, colorants, stabilizers, water soluble inerts, and mixtures thereof.

33. The organic agricultural composition of claim 19, wherein the composition in the form of liquid suspension further comprises at least one agrochemically acceptable excipient selected from structuring agent, surfactants including organic surfactants, humectants, solvents, water miscible solvents, spreading agent, suspending agents or suspension aid or anti-settling, penetrating agent, sticking agents, drift reducing agents, preservatives, stabilizers, buffers or pH adjusters or neutralizing agents, antifreezing agent or freeze point depressants, antifoaming agents.

34. A process of preparing the organic agricultural composition of claim 19, in the form of water dispersible granules, the process comprising:
a. milling blend of elemental sulphur and at least one hydrocolloid to obtain a slurry or wet mix; wherein the hydrocolloid has viscosity of less than 400 cps at ≤30% (w/w) aqueous dispersion of the hydrocolloid to provide a particle size of 0.1μ-25μ; and
b. drying the wet mix to obtain the water dispersible granular composition; wherein the granules of the composition comprise of granules in size range of 0.1 mm to 2.5 mm.

35. A process of preparing the organic agricultural composition of claim 19, in the form of spheronised granules, the process comprising:
a. milling blend of elemental sulphur and at least one hydrocolloid to obtain a slurry or wet mix; wherein the hydrocolloid has viscosity of less than 400 cps at ≤30% (w/w) aqueous dispersion of the hydrocolloid to provide a particle size of 0.1μ-25μ;
b. drying the wet mix to obtain the water dispersible granular composition; wherein the granules of the composition comprise of granules in size range of 0.1 mm to 2.5 mm; and
c. water is added to the dry powder and the mixture is blended to obtain a dough or paste, which is then extruded through an extruder to obtain the extruded granules in a size range of 0.1 mm to 6 mm; or
agglomerating the wet mix or dry powder obtained in step (b) in an agglomerator to obtain granular composition in a size range of 0.1 mm to 6 mm.

36. A process of preparing the organic agricultural composition of claim 19, in a liquid suspension form, wherein the process comprises:
homogenizing mixture of elemental sulphur and at least one hydrocolloid; wherein the hydrocolloid has viscosity of less than 400 cps at ≤30% (w/w) aqueous dispersion of the hydrocolloid; and
wet milling the obtained suspension to provide composition with a particle size range of 0.1 micron to 25 microns.
